(19) United States
(12) Patent Application Publication
(10) Pub. No.: US 2023/0194720 A1
(43) Pub. Date: Jun. 22, 2023

(54) SCHEDULING SYSTEM, SCHEDULING DEVICE, SCHEDULING METHOD, AND COMPUTER READABLE MEDIUM

(71) Applicant: NEC Corporation, Minato-ku, Tokyo (JP)

(72) Inventor: Akira TSUJI, Tokyo (JP)

(73) Assignee: NEC Corporation, Minato-ku, Tokyo (JP)

(21) Appl. No.: 17/926,658

(22) PCT Filed: May 27, 2020
(86) PCT No.: PCT/JP2020/020827

§ 371 Date: Nov. 21, 2022

(51) Int. Cl. G01S 17/89; G01S 7/48; G01W 1/10

(52) U.S. Cl. CPC G01S 17/89; G01S 7/4808; G01W 1/10

(57) ABSTRACT

A scheduling system according to the present disclosure includes a measurement unit that acquires at least brightness data indicating intensity of reflected light of a beam by performing measurement, a scheduler that schedules a measurement date on and time at which the measurement unit performs the measurement, and a measurement data evaluation unit that holds in advance reference brightness data, the reference brightness data being the brightness data acquired by the measurement unit in the past when weather was fine, and evaluate whether a difference between the brightness data acquired by the measurement unit and the reference brightness data is greater than or equal to a threshold value. When a result of the evaluation by the measurement data evaluation unit indicates that the difference is greater than or equal to the threshold value, the scheduler reschedules the measurement date on and time at which the measurement unit performs the measurement.

### TECHNICAL FIELD

The present disclosure relates to a scheduling system, a scheduling device, a scheduling method, and computer readable media.

### BACKGROUND ART

3D-LiDAR (Light Detection And Ranging) is a technique that uses light to measure a distance to a target and a shape of the target. 3D-LiDAR can measure a distance to a target and a shape of the target covering a wide area by using, for example, the Time of Flight (ToF) method, and is therefore used for inspection of infrastructure facilities.

3D-LiDAR acquires measurement data (point cloud data) by irradiating a target with a beam. An example of a related technique for conducting inspections using point cloud data is the technique disclosed in Patent Literature 1.

### CITATION LIST

### Patent Literature

Patent Literature 1: Japanese Unexamined Patent Application Publication No. 2018-165726

### SUMMARY OF INVENTION

### Technical Problem

By the way, the measurement data (point cloud data) acquired by 3D-LiDAR includes not only three-dimensional data indicating the distance to the target and the shape of the target but also brightness data indicating intensity of reflected light of the beam.

However, brightness data is affected by whether the target is wet or not. For example, wet concrete has less reflective brightness.

Therefore, for example, when an abnormality is detected based on a difference between present brightness data and past brightness data, the difference between the brightness data acquired at a wet spot and the past brightness data becomes large. As a result, wet spots may be detected as abnormal spots, even if they are not actually abnormal.

For this reason, when 3D-LiDAR measurement data is acquired outdoors, it is necessary to take weather into consideration.

An object of the present disclosure is to provide a scheduling system, a scheduling device, a scheduling method, and a computer readable medium that can solve the above problem and acquire measurement data by taking weather into consideration.

### Solution to Problem

In an example aspect, a scheduling system includes:

a measurement unit configured to acquire at least brightness data indicating intensity of reflected light of a beam by performing measurement;

a scheduler configured to schedule a measurement date on and time at which the measurement unit performs the measurement; and

a measurement data evaluation unit configured to hold in advance reference brightness data, the reference brightness data being the brightness data acquired by the measurement unit in the past when weather was fine, and evaluate whether a difference between the brightness data acquired by the measurement unit and the reference brightness data is greater than or equal to a threshold value.

When a result of the evaluation by the measurement data evaluation unit indicates that the difference is greater than or equal to the threshold value, the scheduler reschedules the measurement date on and time at which the measurement unit performs the measurement.

In another example aspect, a scheduling device includes:

a scheduler configured to schedule a measurement date on and time at which a measurement unit performs measurement, the measurement unit being configured to acquire at least brightness data indicating intensity of reflected light of a beam by performing the measurement; and

a measurement data evaluation unit configured to hold in advance reference brightness data, the reference brightness data being the brightness data acquired by the measurement unit in the past when weather was fine, and evaluate whether a difference between the brightness data acquired by the measurement unit and the reference brightness data is greater than or equal to a threshold value.

When a result of the evaluation by the measurement data evaluation unit indicates that the difference is greater than or equal to the threshold value, the scheduler reschedules the measurement date on and time at which the measurement unit performs the measurement.

In another example aspect, a scheduling method performed by a scheduling device configured to schedule a measurement date on and time at which a measurement unit performs measurement, the measurement unit being configured to acquire at least brightness data indicating intensity of reflected light of a beam by performing the measurement. The scheduling method includes:

a first step of holding in advance reference brightness data, the reference brightness data being the brightness data acquired by the measurement unit in the past when weather was fine;

a second step of evaluating whether a difference between the brightness data acquired by the measurement unit and the reference brightness data is greater than or equal to a threshold value; and

a third step of rescheduling the measurement date on and time at which the measurement unit performs the measurement when a result of the evaluation indicates that the difference is greater than or equal to the threshold value.

In another example aspect, a non-transitory computer readable medium storing a program for causing a computer for scheduling measurement date on and time at which a measurement unit performs measurement, the measurement unit being configured to acquire at least brightness data indicating intensity of reflected light of a beam by performing the measurement to execute:

a first procedure of holding in advance reference brightness data, the reference brightness data being the brightness data acquired by the measurement unit in the past when weather was fine;

a second procedure of evaluating whether a difference between the brightness data acquired by the measurement unit and the reference brightness data is greater than or equal to a threshold value; and

a third procedure of rescheduling the measurement date on and time at which the measurement unit performs the measurement when a result of the evaluation indicates that the difference is greater than or equal to the threshold value.

### Advantageous Effects of Invention

According to the above example aspects, it is possible to achieve an effect of providing a scheduling system, a scheduling device, a scheduling method, and a computer readable medium that can solve the above problem and acquire measurement data by taking weather into consideration.

### BRIEF DESCRIPTION OF DRAWINGS

FIG. 1 shows an example of a configuration of a scheduling system according to a first example embodiment;

FIG. 2 is a flowchart showing an example of a flow of an overall operation of the scheduling system according to the first example embodiment;

FIG. 3 shows an example of a configuration of a scheduling system according to a second example embodiment;

FIG. 4 is a flowchart showing an example of a flow of an overall operation of the scheduling system according to the second example embodiment;

FIG. 5 is a flowchart showing an example of a flow of a rescheduling operation of a scheduling system according to a third example embodiment;

FIG. 6 shows an example of a GUI screen created by a scheduler according to another example embodiment; and

FIG. 7 is a block diagram showing an example of a hardware configuration of a computer for implementing a scheduling device according to the example embodiments.

### EXAMPLE EMBODIMENT

Hereinafter, example embodiments of the present disclosure will be described with reference to the drawings. The following descriptions and drawings have been omitted and simplified as appropriate for clarity of explanation. In each of the drawings below, the same elements are denoted by the same signs, and repeated descriptions are omitted as necessary.

In addition, each of the example embodiments described below is assumed to be used for scheduling measurement date and time of a measurement unit including 3D-LiDAR when a field such as outdoor infrastructure equipment is inspected. More specifically, each example embodiment assumes that the measurement unit including 3D-LiDAR is installed in the field and used for scheduling the measurement date and time of the measurement unit when the measurement unit uses the measurement data acquired in the measurement to detect abnormalities in the field. However, the use of each example embodiment is not limited to this.

### First Example Embodiment

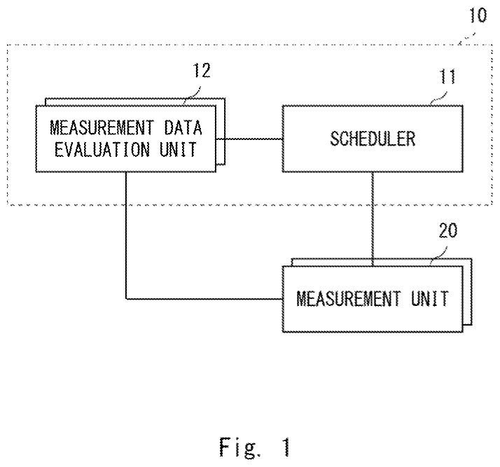

First, a configuration example of a scheduling system according to a first example embodiment will be described with reference to FIG. 1.

As shown in FIG. 1, the scheduling system according to the first example embodiment includes a scheduling device 10 and measurement units 20. The scheduling device 10 also includes a scheduler 11 and measurement data evaluation units 12.

In FIG. 1, a plurality of the measurement units 20 and a plurality of the measurement data evaluation units 12 are provided, but the present disclosure is not limited to this. One or more measurement units 20 may be provided. The measurement data evaluation unit 12 is provided corresponding to the measurement unit 20, and as many measurement data evaluation units 12 as the measurement units 20 are provided.

Each measurement unit 20 is installed at an outdoor field and includes 3D-LiDAR (not shown). Each measurement unit 20 performs measurement using 3D-LiDAR. At the time of measurement, each measurement unit 20 acquires measurement data (point cloud data) by irradiating a target present at the field with a beam, and transmits the acquired measurement data to a processing unit (not shown) that inspects the field where the measurement unit 20 is installed and the corresponding measurement data evaluation unit 12.

Here, each measurement unit 20 can acquire, as the measurement data, three-dimensional data indicating a distance to the target and a shape of the target, and brightness data indicating intensity of reflected light of the beam. However, in the first example embodiment and second and third example embodiments to be described later, each measurement unit 20 only needs to acquire at least the brightness data as the measurement data. Therefore, in the first example embodiment and second and third example embodiments to be described later, each measurement unit 20 acquires brightness data as measurement data, and three-dimensional data may or may not be acquired.

Each measurement unit 20 is assigned a unique identifier that uniquely identifies the measurement unit 20.

The scheduling device 10 is, for example, disposed on a cloud. However, the measurement data evaluation unit 12 may be disposed outside the scheduling device 10. For example, the measurement data evaluation unit 12 may be located at the field where the corresponding measurement unit 20 is installed, or the measurement data evaluation unit 12 may be built into the corresponding measurement unit 20.

The scheduler 11 schedules (sets) the measurement date and time (timing) when each measurement unit 20 performs measurement, and manages the measurement date and time of each measurement unit 20. The scheduler 11 manages a minimum measurement interval which should be satisfied and the last measurement date and time for each measurement unit 20, and schedules the next measurement date and time for each measurement unit 20 so as to satisfy the measurement interval for each measurement unit 20. The scheduler 11 may schedule a default measurement date and time of each measurement unit 20 to perform measurement at regular intervals (e.g., measurement is performed daily at 0 o'clock).

The scheduler 11 transmits a measurement instruction to each measurement unit 20. For example, the scheduler 11 transmits the measurement instruction indicating the measurement date and time to the measurement unit 20, and the measurement unit 20 may perform measurement at the timing of the instructed measurement date and time. Alternatively, the scheduler 11 may transmit a measurement instruction to the measurement unit 20 at the timing of the measurement date and time, and the measurement unit 20 may perform measurement at the timing when the measurement instruction is received.

Each measurement data evaluation unit 12 holds in advance reference brightness data, which is brightness data acquired by the corresponding measurement unit 20 in the past when the weather was fine. In the present specification, fine weather is defined as weather in which there is a low likelihood that a target present at an outdoor field will get wet. More specifically, weather such as rain, snow, and fog is defined as bad weather because the target is likely to get wet, and weather other than bad weather is defined as fine weather.

Each measurement data evaluation unit 12 receives the brightness data acquired by the corresponding measurement unit 20 from the corresponding measurement unit 20. Each measurement data evaluation unit 12 evaluates whether a difference between the reference brightness data of the corresponding measurement unit 20 and the latest brightness data thereof acquired by the corresponding measurement unit 20 is greater than or equal to a threshold value. For example, each measurement data evaluation unit 12 evaluates whether there is a change greater than or equal to a threshold value in the brightness of the two pieces of brightness data. When an evaluation result indicates that the difference between the two pieces of brightness data is greater than or equal to the threshold value, each measurement data evaluation unit 12 generates an alarm to notify that the difference between them is greater than or equal to the threshold value and transmits the generated alarm to the scheduler 11. At this time, each measurement data evaluation unit 12 includes the identifier of the corresponding measurement unit 20 in the alarm.

When the scheduler 11 receives the alarm from any of the measurement data evaluation units 12, it reschedules the measurement date and time of the measurement unit 20 (this measurement unit 20 shall be referred to as a measurement unit 20X here) whose identifier is included in the alarm. For example, if the scheduler 11 has scheduled the measurement date and time of the measurement unit 20X within a certain period of time from the present time, it can be considered that the scheduler 11 reschedules the measurement date and time to a later date and time.

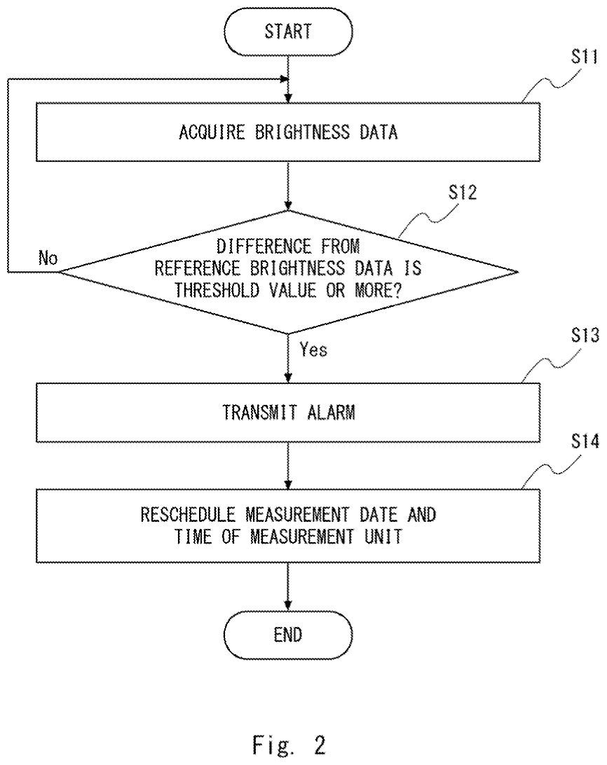

Next, an example of a flow of an overall operation of the scheduling system according to the first example embodiment will be described with reference to FIG. 2. In FIG. 2, it is assumed that each measurement unit 20 has a default measurement date and time scheduled by the scheduler 11.

As shown in FIG. 2, each measurement unit 20 performs measurement at the measurement date and time scheduled by the scheduler 11, acquires the brightness data in the measurement, and transmits the acquired brightness data to the corresponding measurement data evaluation unit 12 (Step S11).

Each measurement data evaluation unit 12 evaluates whether the difference between the reference brightness data of the corresponding measurement unit 20 and the brightness data acquired by the corresponding measurement unit 20 is greater than or equal to the threshold value (Step S12). If the evaluation result indicates that the difference between the two pieces of the brightness data is not greater than or equal to the threshold value (No in Step S12), the processing returns to Step S11.

On the other hand, if the evaluation result indicates that the difference between the reference brightness data and the brightness data is greater than or equal to the threshold value (Yes in Step S12), each measurement data evaluation unit 12 transmits an alarm including the identifier of the corresponding measurement unit 20 to the scheduler 11 (Step S13).

When the scheduler 11 receives the alarm from any of the measurement data evaluation units 12, it reschedules the measurement date and time of the measurement unit 20 whose identifier is included in the alarm (Step S14).

As described above, according to the first example embodiment, the measurement data evaluation unit 12 holds in advance the reference brightness data, which is the brightness data acquired by the measurement unit 20 in the past when the weather was fine. The measurement data evaluation unit 12 evaluates whether or not the difference between the reference brightness data and the brightness data in the measurement unit 20 is greater than or equal to the threshold value. When the evaluation result indicates that the difference between the two pieces of the brightness data is greater than or equal to the threshold value, the scheduler 11 reschedules the measurement date and time of the measurement unit 20.

Therefore, when the brightness data of the measurement unit 20 is changed significantly from the reference brightness data, the scheduler 11 determines that a place where the measurement unit 20 is installed is in bad weather and can reschedule the measurement date and time of the measurement unit 20. Therefore, the weather can be taken into consideration to acquire the measurement data of the measurement unit 20. As a result, it is possible to reduce that wet spots are detected as abnormal spots.

### Second Example Embodiment

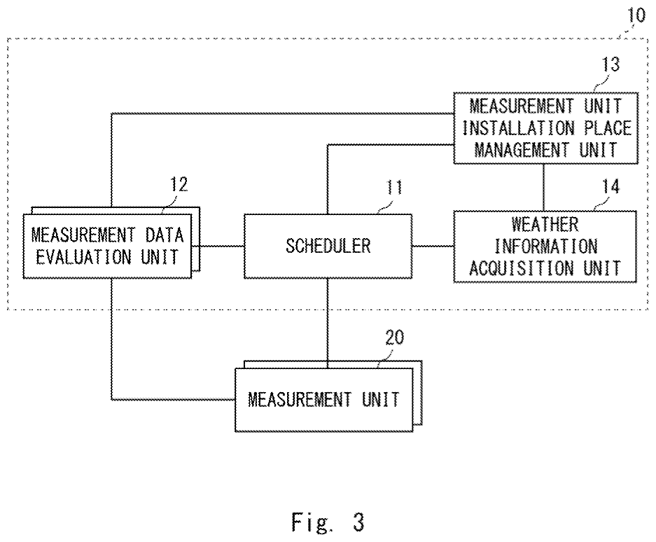

Next, a configuration example of a scheduling system according to a second example embodiment will be described with reference to FIG. 3.

As shown in FIG. 3, the scheduling system according to the second example embodiment differs from the configuration according to the first example embodiment described above in that, the scheduling system according to the second example embodiment further includes a measurement unit installation place management unit 13 and a weather information acquisition unit 14 inside the scheduling device 10.

For each measurement unit 20, the measurement unit installation place management unit 13 holds in advance installation place information indicating the installation place where the measurement unit 20 is installed and the area including the installation place and the like. The installation place may be indicated by latitude and longitude or an address. The area may be an area divided by any unit, such as an area divided by prefecture, or an area divided by municipality. The measurement unit installation place management unit 13 holds the installation place information about the measurement unit 20 in association with the identifier of the measurement unit 20.

The weather information acquisition unit 14 acquires weather information about the area including the installation place of the measurement unit 20 instructed by the scheduler 11 from a source such as the Internet. The weather information may be, for example, information about weather forecast. The scheduler 11 notifies the weather information acquisition unit 14 of the identifier or the installation place of the measurement unit 20. When the scheduler 11 notifies the weather information acquisition unit 14 of the identifier of the measurement unit 20, the weather information acquisition unit 14 may identify the installation place of the measurement unit 20 by referring to the measurement unit installation place management unit 13 by using the identifier of the measurement unit 20 as a key.

The weather information acquisition unit 14 may acquire the weather information from all over the country and extract, from the weather information from all over the country, weather information about the area including the installation place of the measurement unit 20 instructed by the scheduler 11. Alternatively, the weather information acquisition unit 14 may use the installation place of the measurement unit 20 instructed by the scheduler 11 as a key to acquire only the weather information about the area including the installation place.

When the weather information acquisition unit 14 acquires the weather information about the area including the installation place of the measurement unit 20 instructed by the scheduler 11, it returns the acquired weather information to the scheduler 11.

In the second example embodiment, the scheduler 11 and the measurement data evaluation unit 12 operate as follows.

In a manner similar to that of the above first example embodiment, each measurement data evaluation unit 12 evaluates whether the difference between the reference brightness data of the corresponding measurement unit 20 and latest brightness data thereof is greater than or equal to the threshold value, and if the difference between the two pieces of the brightness data is greater than or equal to the threshold value, the measurement data evaluation unit 12 transmits an alarm notifying the scheduler 11 to that effect. At this time, each measurement data evaluation unit 12 includes the identifier of the corresponding measurement unit 20 in the alarm. Alternatively, each measurement data evaluation unit 12 uses the identifier of the corresponding measurement unit 20 as a key to refer to the measurement unit installation place management unit 13 in order to identify the installation place of the corresponding measurement unit 20, and includes the identified installation place in the alarm.

When the scheduler 11 receives the alarm from any of the measurement data evaluation units 12, it instructs the weather information acquisition unit 14 to acquire the weather information about the area including the installation place of the measurement unit 20 (this measurement unit 20 shall be referred to as the measurement unit 20X here) whose identifier or installation place is included in the alarm. At this time, if the installation place of the measurement unit 20X is included in the alarm, the scheduler 11 only has to indicate the installation place. When the alarm includes the identifier of the measurement unit 20X, the scheduler 11 may indicate the identifier, or may use the identifier as a key to refer to the measurement unit installation place management unit 13, identify the installation place of the measurement unit 20X, and then indicate the identified installation place.

When the weather information about the area including the installation place of the measurement unit 20X acquired from the weather information acquisition unit 14 indicates bad weather, the scheduler 11 reschedules the measurement date and time of the measurement unit 20X based on the weather information. For example, it can be considered that, based on the weather information, the scheduler 11 identifies a time period of bad weather and a time period for a certain period of time right after the weather improves and reschedules the measurement date and time of the measurement unit 20X so that the measurement is performed avoiding the identified time periods.

At this time, another measurement unit 20 may be installed in the same area as the area where the measurement unit 20X is installed. In this case, the installation place of the other measurement unit 20 may also be in bad weather, and the target present at the field where the other measurement unit 20 is installed may get wet.

Therefore, when the weather information about the area acquired from the weather information acquisition unit 14 indicates bad weather, the scheduler 11 may refer to the measurement unit installation place management unit 13, identify all measurement units 20 (including the measurement unit 20X) installed in the area, and reschedule the measurement dates and times of all identified measurement units 20.

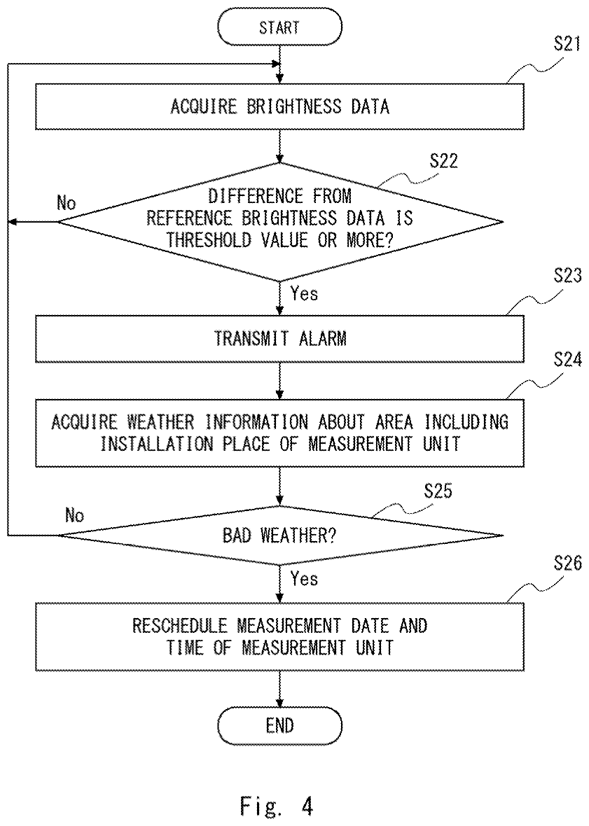

Hereinafter, an example of the flow of the overall operation of the scheduling system according to the second example embodiment will be described with reference to FIG. 4. In FIG. 4, it is assumed that each measurement unit 20 has a default measurement date and time scheduled by the scheduler 11.

As shown in FIG. 4, Steps S21 to S23 similar to Steps S11 to S13 in FIG. 2, respectively, are performed first. However, in Step S23, unlike in Step S13, each measurement data evaluation unit 12 includes the identifier or installation place of the corresponding measurement unit 20 in the alarm.

When the scheduler 11 receives the alarm from any of the measurement data evaluation units 12, it instructs the weather information acquisition unit 14 to acquire the weather information about the area including the installation place of the measurement unit 20 (this measurement unit 20 shall be referred to as the measurement unit 20X here) whose identifier or installation place is included in the alarm, and acquires the weather information about the area from the weather information acquisition unit 14 (Step S24).

Next, the scheduler 11 determines whether the weather information about the area including the installation place of the measurement unit 20X indicates bad weather (Step S25). If the weather information does not indicate bad weather (No in Step S25), the processing returns to Step S21.

On the other hand, if the weather information indicates bad weather (Yes in Step S25), the scheduler 11 reschedules the measurement date and time of the measurement unit 20X based on the weather information (Step S26). At this time, the scheduler 11 may reschedule the measurement dates and times of all the measurement units 20 installed in the same area as the area where the measurement unit 20X is installed.

As described above, according to the second example embodiment, for example, when the scheduler 11 receives the alarm from the measurement data evaluation unit 12X corresponding to the measurement unit 20X, it acquires the weather information about the area including the installation place of the measurement unit 20X, and if the weather information indicates bad weather, the scheduler 11 reschedules the measurement date and time of the measurement unit 20X.

Therefore, when the brightness data of the measurement unit 20X is changed significantly from the reference brightness data, the scheduler 11 can determine that the installation place of the measurement unit 20X may be in bad weather, and acquire weather information about the area including the installation place of the measurement unit 20X. If the weather of the installation place of the measurement unit X is actually bad weather, the scheduler 11 can reschedule the measurement date and time of the measurement unit 20X. Therefore, as compared with the first example embodiment described above, the measurement date and time of the measurement unit 20X can be rescheduled after it is determined with higher accuracy that the installation place of the measurement unit 20X is in bad weather.

According to the second example embodiment, when the weather information about the area including the installation place of the measurement unit 20X indicates bad weather, the measurement dates and times of all measurement units 20 installed in the same area as the area where the measurement unit 20X is installed may be rescheduled. By doing so, the measurement dates and times of all the measurement units 20 installed in the same area as the area where the measurement unit 20X is installed can be collectively rescheduled.

Other effects are the same as those in the first example embodiment described above.

### Third Example Embodiment

A scheduling system according to a third example embodiment has the same configuration as that of the second example embodiment described above, but operates differently.

In the above second example embodiment, the measurement date and time of each measurement unit 20 scheduled by the scheduler 11 is the measurement date and time when each measurement unit 20 performs measurement for inspection.

In the above second example embodiments, for example, when the scheduler 11 reschedules the measurement date and time of the measurement unit 20X for inspection, the scheduler 11 decides that the measurement unit 20X should perform the measurement for inspection, avoiding the time period when the installation place of the measurement unit 20X is in bad weather and the time period for a certain period of time right after the weather improves.

However, it can be considered that even after a certain period of time has elapsed right after the weather improves, there may still be wet spots. In this case, if an inspection is performed using the brightness data of a wet spot, a difference between the brightness data and the reference brightness data is considered to be large, and therefore, the wet spot may be detected as an abnormal spot.

Thus, in the third example embodiment, when the measurement date and time of the measurement unit 20 (this measurement unit shall be referred to as the measurement unit 20X here) for inspection is rescheduled, the measurement unit 20X first performs measurement for checking weather at short intervals. Since this measurement is not for inspection, the brightness data acquired by this measurement will not be used for inspection. Then, after the difference between the reference brightness data and the brightness data of the measurement unit 20X becomes less than the threshold value, the measurement unit 20X decides to perform the measurement for inspection.

In the third example embodiment, the operations of the measurement unit installation place management unit 13 and the weather information acquisition unit 14 are the same as those in the second example embodiment described above. On the other hand, the scheduler 11 and the measurement data evaluation unit 12 operate as follows. Here, the operation when an alarm is transmitted from the measurement data evaluation unit 12X corresponding to the measurement unit 20X is described.

The scheduler 11 acquires the weather information about the area including the installation place of the measurement unit 20X from the weather information acquisition unit 14. If the weather information indicates bad weather, the scheduler 11 reschedules the measurement date and time of the measurement unit 20X for inspection. In this case, the scheduler 11 first acquires, based on the weather information, the time period during which the area is in bad weather and the date and time when the weather in the area is expected to improve.

The scheduler 11 determines that the measurement unit 20X does not perform measurement for inspection during the time period of bad weather.

At the date and time when the weather is expected to improve, the scheduler 11 transmits a measurement instruction to the measurement unit 20X instructing the measurement unit to perform the measurement for checking the weather at short measurement intervals. The measurement interval for checking the weather should be shorter than the measurement interval for inspection. For example, if the measurement interval for inspection is one day, the measurement interval for checking the weather may be 12 hours, 6 hours, 1 hour, etc.

After that, the measurement unit 20X performs measurement for checking the weather at the measurement interval instructed by the scheduler 11, and transmits the brightness data acquired by the measurement to the corresponding measurement data evaluation unit 12X.

The measurement data evaluation unit 12X evaluates whether the difference between the reference brightness data of the measurement unit 20X and the latest brightness data thereof acquired by the measurement unit 20X has become less than the threshold value. When the evaluation result indicates that the difference between the two pieces of the brightness data has become less than the threshold value, the measurement data evaluation unit 12X generates an alarm cancel notification indicating that the difference between the two pieces of the brightness data has become less than the threshold value, and transmits the generated alarm cancel notification to the scheduler 11. At this time, the measurement data evaluation unit 12X includes the identifier or installation place of the measurement unit 20X in the alarm cancel notification.

When the scheduler 11 receives the alarm cancel notification from the measurement data evaluation unit 12X, it decides that the measurement unit 20X will perform the measurement for inspection on or after the date and time when the alarm cancel notification is received.

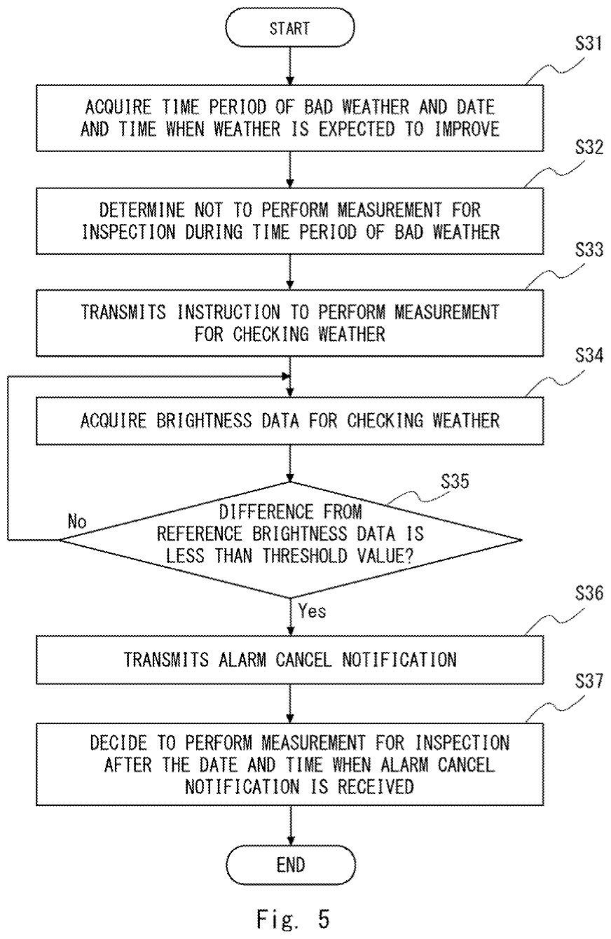

Next, the operation of the scheduling system according to the third example embodiment will be described. However, the flow of the overall operation of the scheduling system according to the third example embodiment is the same as that shown in FIG. 4 according to the second example embodiment described above. Hereinafter, an example of the flow of a rescheduling operation (corresponding to Step S26 in FIG. 4) of the scheduling system according to the third example embodiment will be described with reference to FIG. 5. In FIG. 5, the measurement date and time of the measurement unit 20X for inspection are rescheduled.

As shown in FIG. 5, the scheduler 11 first acquires, based on the weather information about the area including the installation place of the measurement unit 20X acquired from the weather information acquisition unit 14, the time period during which the area is in bad weather and the date and time when the weather in the area is expected to improve (Step S31)

The scheduler 11 determines that the measurement unit 20X does not perform measurement for inspection during the time period of bad weather (Step S32).

At the date and time when the weather is expected to improve, the scheduler 11 transmits a measurement instruction to the measurement unit 20X instructing the measurement unit to perform the measurement for checking the weather at short measurement intervals (Step S33).

In response, the measurement unit 20X performs measurement for checking the weather at the measurement interval instructed by the scheduler 11, and transmits the brightness data acquired by the measurement to the corresponding measurement data evaluation unit 12X (Step S34).

The measurement data evaluation unit 12X evaluates whether the difference between the reference brightness data of the measurement unit 20X and the brightness data for checking the weather acquired by the measurement unit 20X has become less than the threshold value (Step S35). If the evaluation result indicates that the difference between the two pieces of the brightness data is not less than the threshold value (No in Step S35), the processing returns to Step S34.

On the other hand, if the evaluation result indicates that the difference between the reference brightness data and the brightness data has become less than the threshold value (Yes in Step S35), the measurement data evaluation unit 12X transmits an alarm cancel notification including the identifier or installation place of the measurement unit 20X to the scheduler 11 (Step S36).

When the scheduler 11 receives the alarm cancel notification from the measurement data evaluation unit 12X, it decides that the measurement unit 20X will perform the measurement for inspection on or after the date and time when the alarm cancel notification is received (Step S37).

As described above, according to the third example embodiment, when the scheduler 11 reschedules, for example, the measurement date and time of the measurement unit 20X for inspection, it instructs the measurement unit 20X to perform the measurement for checking the weather. When the difference between the reference brightness data of the measurement unit 20X and the brightness data becomes less than the threshold value, the measurement data evaluation unit 12X transmits the alarm cancel notification to the scheduler 11. The scheduler 11 determines that the measurement unit 20X will perform the measurement for inspection on or after the date and time when the alarm cancel notification is received from the measurement data evaluation unit 12X.

Here, when the difference between the reference brightness data and the brightness data of the measurement unit 20X becomes less than the threshold value, it means that the spot that had been wet due to rainfall or the like has become dry and in its original state. Therefore, the scheduler 11 can make the measurement unit 20X perform the measurement for inspection after it is determined with high accuracy that the wet spot due to rainfall or the like has dried. As a result, it is possible to further reduce detection of wet spots as abnormal spots.

Other effects are the same as those in the second example embodiment described above.

### Another First Example Embodiment

As described above, each measurement data evaluation unit 12 evaluates whether the difference between the reference brightness data of the corresponding measurement unit 20 and the brightness data acquired by the corresponding measurement unit 20 for inspection is greater than or equal to the threshold value.

However, at the field where the measurement unit 20 is installed, there are a variety of targets to be inspected. For the same environmental change (e.g., rainfall etc.), some of the targets to be inspected have a large number of changes in brightness data, while others have a small number of changes in brightness data. For example, if the field is a substation, there are targets that are made of various materials and have various shapes, such as concrete foundations, ceramic insulators, and metal iron structures.

Therefore, each measurement unit 20 may further acquire three-dimensional data as the measurement data, and each measurement data evaluation unit 12 may capture a change in the brightness of the brightness data by using any of the following first to third methods based on the three-dimensional data.

### (1) First Method

Brightness of targets made of concrete or the like is likely to be changed in brightness data due to rainfall, etc. In the first method, therefore, a target made of concrete or the like is defined as a specific target, and a change in brightness is captured by using brightness data indicating intensity of reflected light reflected by the specific target among reflected lights of the beam.

Specifically, each measurement data evaluation unit 12 is present at the field where the corresponding measurement unit 20 is installed, and the position of a specific target made of concrete or the like is specified in advance.

Each measurement data evaluation unit 12 extracts, based on the three-dimensional data of the corresponding measurement unit 20, from the reference brightness data of the corresponding measurement unit 20, brightness data indicating the intensity of reflected light reflected by the specific target specified in advance.

Each measurement data evaluation unit 12 extracts brightness data indicating the intensity of reflected light reflected by a specific object specified in advance from the brightness data of the corresponding measurement unit 20 based on the three-dimensional data of the corresponding measurement unit 20.

Next, each measurement data evaluation unit 12 evaluates whether the difference between the brightness data extracted from the brightness data of the corresponding measurement unit 20 and the brightness data extracted from the reference brightness data of the corresponding measurement unit 20 is greater than or equal to the threshold value, and if it is greater than or equal to the threshold value, an alarm is transmitted.

### (2) Second Method

Targets with complex shapes have large variations in brightness in the brightness data. In the second method, therefore, a target with a complex shape is selected as a specific target, the brightness data indicating the intensity of reflected light reflected by the specific target is excluded from reflected light of the beam, and the remaining brightness data is used to capture the change in the brightness.

Specifically, each measurement data evaluation unit 12 attempts to detect a target with a complex shape that is present at the field where the corresponding measurement unit 20 is installed, based on the three-dimensional data of the corresponding measurement unit 20. When a target with a complex shape is detected, each measurement data evaluation unit 12 determines the detected target to be a specific target. At this time, each measurement data evaluation unit 12 may calculate the complexity of the shape using the roughness of the surface shape, a distribution of the orientation of the normal vector, etc. For example, areas paved with gravel or crushed stone (such as railroad tracks) are detected as target with complex shapes because of their large roughness.

Each measurement data evaluation unit 12 extracts the brightness data other than the brightness data indicating the intensity of reflected light reflected by the specific target determined above from the reference brightness data of the corresponding measurement unit 20 based on the three-dimensional data of the corresponding measurement unit 20.

Further, each measurement data evaluation unit 12 extracts the brightness data other than the brightness data indicating the intensity of reflected light reflected by the specific target determined above from the brightness data of the corresponding measurement unit 20 based on the three-dimensional data of the corresponding measurement unit 20.

Next, each measurement data evaluation unit 12 evaluates whether the difference between the brightness data extracted from the brightness data of the corresponding measurement unit 20 and the brightness data extracted from the reference brightness data of the corresponding measurement unit 20 is greater than or equal to the threshold value, and if it is greater than or equal to the threshold value, an alarm is transmitted.

In the second method, each measurement data evaluation unit 12 detects a specific target with a complex shape, but the present disclosure is not limited to this. The position of a specific target having a complicated shape may be specified in advance in each measurement data evaluation unit 12.

### (3) Third Method

In spots that are not horizontal to the ground, even if there is rainfall or the like, a change in the brightness in the brightness data may not be captured due to, for example, water flowing. In the third method, therefore, a spot that is approximately horizontal to the ground is defined as a specific target, and a change in brightness is captured by using brightness data indicating intensity of reflected light reflected by the specific target among reflected lights of the beam.

Specifically, each measurement data evaluation unit 12 attempts to detect a spot that is approximately horizontal to the ground, which is present at the field where the corresponding measurement unit 20 is installed, based on the three-dimensional data of the corresponding measurement unit 20. When each measurement data evaluation unit 12 detects a spot that is approximately horizontal to the ground, it determines the detected spot as a specific target. The spot is determined to be approximately horizontal by, for example, calculating a normal vector based on three-dimensional data and determining whether an orientation of the normal vector is approximately vertical.

Each measurement data evaluation unit 12 then extracts the brightness data indicating the intensity of reflected light reflected by the specific object determined above from the reference brightness data of the corresponding measurement unit 20 based on the three-dimensional data of the corresponding measurement unit 20.

Each measurement data evaluation unit 12 extracts the brightness data indicating the intensity of reflected light reflected by the specific object determined above from the brightness data of the corresponding measurement unit 20 based on the three-dimensional data of the corresponding measurement unit 20.

Next, each measurement data evaluation unit 12 evaluates whether the difference between the brightness data extracted from the brightness data of the corresponding measurement unit 20 and the brightness data extracted from the reference brightness data of the corresponding measurement unit 20 is greater than or equal to a threshold value, and if it is greater than or equal to the threshold value, an alarm is transmitted.

In the third method, each measurement data evaluation unit 12 detects a specific target that is approximately horizontal to the ground, but the present disclosure is not limited to this. In each measurement data evaluation unit 12, the position of a specific target that is approximately horizontal to the ground may be specified in advance.

In the third method, each measurement data evaluation unit 12 transmits an alarm if the difference between the brightness data of the specific target is greater than or equal to the threshold value, but the present disclosure is not limited to this. Each measurement data evaluation unit 12 may measure the difference between the two pieces of the brightness data a plurality of times in a short time and transmit an alarm when a change in the brightness is not stable.

### Another Second Example Embodiment

In the above first to third example embodiments, when the scheduler 11 reschedules the measurement date and time of the measurement unit 20 for inspection, it determines that the measurement unit 20 performs the measurement after the date and time after the weather has improved from bad weather, but the present disclosure is not limited to this.

The scheduler 11 may consider the measurement time required for the measurement by the measurement unit 20 to decide that the measurement unit 20 will perform the measurement before the weather turns bad if the measurement unit 20 can complete the measurement before the weather turns bad.

### Another Third Example Embodiment

In the above first to third example embodiments, the scheduler 11 determines the measurement date and time of the measurement unit 20 for inspection so as to avoid the time period of bad weather, etc. In other words, during such time periods, the measurement unit 20 suspends the measurement for inspection.

Furthermore, in the above second example embodiment, the scheduler 11 can reschedule the measurement dates and times of all the measurement units 20 installed in the area where the weather is bad. In this case, all measurement units 20 installed in the area suspend the measurement for inspection, for example, in a time period when the area is in bad weather.

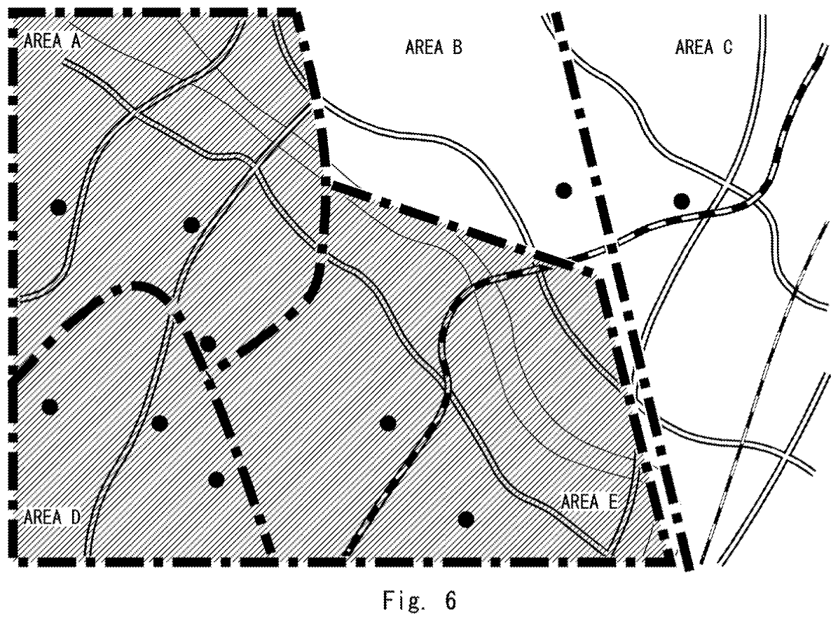

Therefore, the scheduler 11 may notify an administrator or the like who manages an inspection target of the area where the measurement unit 20 is currently suspending the measurement for inspection. At this time, for example, the scheduler 11 may create a GUI (Graphical User Interface) screen on which the area where the measurement unit 20 is currently suspending the measurement for inspection is superimposed on the map, and transmit the created GUI screen to a terminal of the administrator or the like. An example of this GUI screen is shown in FIG. 6.

In the example of FIG. 6, a map including five areas A to E is displayed. In addition, the fields to be inspected where the measurement units 20 are installed are indicated by black circles on the map. In addition, among the areas A to E, the areas where the measurement units 20 are currently suspending the measurement for inspection are the areas A, D, and E. The areas A, D, and E are highlighted by the shaded lines.

### <Hardware Configuration of Scheduling Device According to Example Embodiments>

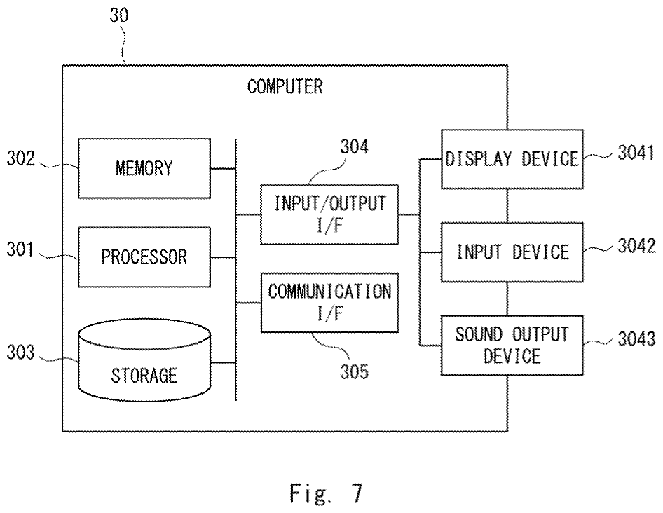

Next, a hardware configuration of a computer 30 for implementing the scheduling device 10 according to the above described example embodiments will be described with reference to FIG. 7.

As shown in FIG. 7, the computer 30 includes a processor 301, a memory 302, a storage 303, an input/output interface (input/output I/F) 304, a communication interface (communication I/F) 305, etc. The processor 301, the memory 302, the storage 303, the input/output interface 304, and the communication interface 305 are connected by a data transmission path for transmitting and receiving data to each other.

The processor 301 is, for example, an arithmetic processing unit such as a CPU (Central Processing Unit) or a GPU (Graphics Processing Unit). The memory 302 is, for example, a memory such as RAM (Random Access Memory) or ROM (Read Only Memory). The storage 303 is, for example, a storage device such as an HDD (Hard Disk Drive), an SSD (Solid State Drive), or a memory card. The storage 303 may be a memory such as RAM or ROM.

The storage 303 stores programs for implementing the functions of the components included in the scheduling device 10. By executing each of these programs, the processor 301 implements the functions of the components included in the scheduling device 10. Here, the processor 301 may execute the above programs after reading them into the memory 302, or may execute them without reading them into the memory 302. The memory 302 and the storage 303 also serve to store information and data held by the components of the scheduling device 10.

Further, the above program can be stored and provided to a computer (including the computer 30) using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc ROM), CD-R (CD-Recordable), CD-R/W (CD-Rewritable), and semiconductor memories (such as mask ROM, PROM (programmable ROM), EPROM (erasable PROM), flash ROM, RAM. The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The input/output interface 304 is connected to a display device 3041, an input device 3042, a sound output device 3043, etc. The display device 3041 is a device that displays a screen corresponding to drawing data processed by the processor 301, such as an LCD (Liquid Crystal Display), CRT (Cathode Ray Tube) display, or monitor. The input device 3042 is a device that accepts the operator's operational input, such as a keyboard, mouse, and touch sensor. The display device 3041 and the input device 3042 may be integrated and implemented as a touch panel. The sound output device 3043 is a device such as a speaker that outputs sound corresponding to the sound data processed by the processor 301.

The communication interface 305 transmits and receives data to and from an external device. For example, the communication interface 305 communicates with the external device via a wired or wireless channel.

Although the present disclosure has been described above with reference to the example embodiments, the disclosure is not limited to the example embodiments described above. Various changes in the configuration and details of the present disclosure may be made that would be understandable to a person skilled in the art within the scope of the present disclosure.

For example, some or all of the above example embodiment may be used in combination with each other.

The whole or part of the exemplary embodiments disclosed above can be described as, but not limited to, the following supplementary notes.

### (Supplementary Note 1)

A scheduling system comprising:

a measurement unit configured to acquire at least brightness data indicating intensity of reflected light of a beam by performing measurement;

a scheduler configured to schedule a measurement date on and time at which the measurement unit performs the measurement; and

a measurement data evaluation unit configured to hold in advance reference brightness data, the reference brightness data being the brightness data acquired by the measurement unit in the past when weather was fine, and evaluate whether a difference between the brightness data acquired by the measurement unit and the reference brightness data is greater than or equal to a threshold value, wherein

when a result of the evaluation by the measurement data evaluation unit indicates that the difference is greater than or equal to the threshold value, the scheduler reschedules the measurement date on and time at which the measurement unit performs the measurement.

### (Supplementary Note 2)

The scheduling system according to Supplementary note 1, further comprising:

an installation place management unit configured to hold installation place information indicating an installation place of the measurement unit in advance; and

a weather information acquisition unit configured to be able to acquire weather information, wherein

when the result of the evaluation by the measurement data evaluation unit indicates that the difference is greater than or equal to the threshold value, the scheduler acquires the weather information about an area including the installation place of the measurement unit from the weather information acquisition unit, and

when weather indicated by the weather information about the area acquired from the weather information acquisition unit is not fine, the scheduler reschedules the measurement date on and time at which the measurement unit performs the measurement.

### (Supplementary Note 3)

The scheduling system according to Supplementary note 2, further comprising:

a plurality of the measurement units, wherein

the installation place management unit holds in advance the installation place information indicating the installation place of each of the plurality of the measurement units, and

when the weather indicated by the weather information about the area acquired from the weather information acquisition unit is not fine, the scheduler refers to the installation place management unit to identify all the measurement units installed in the area, and

the scheduler reschedules the measurement dates and times at which all the measurement units positioned in the area perform the measurement.

### (Supplementary Note 4)

The scheduling system according to Supplementary note 2 or 3, wherein

the scheduler schedules the measurement date and time when the measurement unit performs the measurement for inspection,

when the scheduler reschedules the measurement date on and time at which the measurement unit performs the measurement for inspection, the scheduler acquires, based on the weather information about the area acquired from the weather information acquisition unit, a scheduled date on and time at which the weather in the area is expected to improve, and the scheduler instructs the measurement unit to perform the measurement for checking the weather at the scheduled date and time, and

the measurement data evaluation unit evaluates whether the difference between the brightness data acquired by the measurement unit and the reference brightness data has become less than the threshold value, and

when the result of the evaluation by the measurement data evaluation unit indicates that the difference has become less than the threshold value, the scheduler decides that the measurement unit performs the measurement for inspection on or after a date and time when the difference becomes less than the threshold value.

### (Supplementary Note 5)

The scheduling system according to any one of Supplementary notes 1 to 4, wherein

the measurement unit further acquires three-dimensional data indicating a distance to a target and a shape of the target by performing the measurement,

the measurement data evaluation unit extracts the brightness data indicating the intensity of the reflected light reflected by the specific target from the reference brightness data based on the three-dimensional data,

the measurement data evaluation unit extracts the brightness data indicating the intensity of the reflected light reflected by the specific target from the brightness data acquired by the measurement unit based on the three-dimensional data, and

the measurement data evaluation unit evaluates whether the difference between the brightness data extracted from the brightness data acquired by the measurement unit and the brightness data extracted from the reference brightness data is greater than or equal to the threshold value.

### (Supplementary Note 6)

The scheduling system according to any one of Supplementary notes 1 to 4, wherein

the measurement unit further acquires three-dimensional data indicating a distance to a target and a shape of the target by performing the measurement,

the measurement data evaluation unit extracts brightness data other than brightness data indicating the intensity of the reflected light reflected by the specific target from the reference brightness data based on the three-dimensional data,

the measurement data evaluation unit extracts brightness data other than the brightness data indicating the intensity of the reflected light reflected by the specific target from the brightness data acquired by the measurement unit based on the three-dimensional data, and

the measurement data evaluation unit evaluates whether the difference between the brightness data extracted from the brightness data acquired by the measurement unit and the brightness data extracted from the reference brightness data is greater than or equal to the threshold value.

### (Supplementary Note 7)

A scheduling device comprising:

a scheduler configured to schedule a measurement date on and time at which a measurement unit performs measurement, the measurement unit being configured to acquire at least brightness data indicating intensity of reflected light of a beam by performing the measurement; and

a measurement data evaluation unit configured to hold in advance reference brightness data, the reference brightness data being the brightness data acquired by the measurement unit in the past when weather was fine, and evaluate whether a difference between the brightness data acquired by the measurement unit and the reference brightness data is greater than or equal to a threshold value, wherein

when a result of the evaluation by the measurement data evaluation unit indicates that the difference is greater than or equal to the threshold value, the scheduler reschedules the measurement date on and time at which the measurement unit performs the measurement.

### (Supplementary Note 8)

The scheduling device according to Supplementary note 7, further comprising:

an installation place management unit configured to hold installation place information indicating an installation place of the measurement unit in advance; and

a weather information acquisition unit configured to be able to acquire weather information, wherein

when the result of the evaluation by the measurement data evaluation unit indicates that the difference is greater than or equal to the threshold value, the scheduler acquires the weather information about an area including the installation place of the measurement unit from the weather information acquisition unit, and

when weather indicated by the weather information about the area acquired from the weather information acquisition unit is not fine, the scheduler reschedules the measurement date on and time at which the measurement unit performs the measurement.

### (Supplementary Note 9)

The scheduling device according to Supplementary note 8, wherein

a plurality of the measurement units are provided,

the installation place management unit holds in advance the installation place information indicating the installation place of each of the plurality of the measurement units, and

when the weather indicated by the weather information about the area acquired from the weather information acquisition unit is not fine, the scheduler refers to the installation place management unit to identify all the measurement units installed in the area by referring to the installation place management unit, and

the scheduler reschedules the measurement dates and times when all the measurement units positioned in the area perform the measurement.

### (Supplementary Note 10)

The scheduling device according to Supplementary note 8 or 9, wherein

the scheduler schedules the measurement date and time when the measurement unit performs the measurement for inspection,

when the scheduler reschedules the measurement date on and time at which the measurement unit performs the measurement for inspection, the scheduler acquires, based on the weather information about the area acquired from the weather information acquisition unit, a scheduled date on and time at which the weather in the area is expected to improve, and the scheduler instructs the measurement unit to perform the measurement for checking the weather at the scheduled date and time,

the measurement data evaluation unit evaluates whether the difference between the brightness data acquired by the measurement unit and the reference brightness data has become less than the threshold value, and

when the result of the evaluation by the measurement data evaluation unit indicates that the difference has become less than the threshold value, the scheduler decides that the measurement unit performs the measurement for inspection on or after a date and time when the difference becomes less than the threshold value.

### (Supplementary Note 11)

The scheduling device according to any one of Supplementary notes 7 to 10, wherein

the measurement unit acquires three-dimensional data indicating a distance to a target and a shape of the target by performing the measurement,

the measurement data evaluation unit extracts brightness data other than brightness data indicating the intensity of the reflected light reflected by the specific target from the reference brightness data based on the three-dimensional data,

the measurement data evaluation unit extracts brightness data other than the brightness data indicating the intensity of the reflected light reflected by the specific target from the brightness data acquired by the measurement unit based on the three-dimensional data, and

the measurement data evaluation unit evaluates whether the difference between the brightness data extracted from the brightness data acquired by the measurement unit and the brightness data extracted from the reference brightness data is greater than or equal to the threshold value.

### (Supplementary Note 12)

The scheduling device according to any one of Supplementary notes 7 to 10, wherein

the measurement unit acquires three-dimensional data indicating a distance to a target and a shape of the target by performing the measurement,

the measurement data evaluation unit extracts brightness data other than brightness data indicating the intensity of the reflected light reflected by the specific target from the reference brightness data based on the three-dimensional data,

the measurement data evaluation unit extracts brightness data other than the brightness data indicating the intensity of the reflected light reflected by the specific target from the brightness data acquired by the measurement unit based on the three-dimensional data, and

the measurement data evaluation unit evaluates whether the difference between the brightness data extracted from the brightness data acquired by the measurement unit and the brightness data extracted from the reference brightness data is greater than or equal to the threshold value.

### (Supplementary Note 13)

A scheduling method performed by a scheduling device configured to schedule a measurement date on and time at which a measurement unit performs measurement, the measurement unit being configured to acquire at least brightness data indicating intensity of reflected light of a beam by performing the measurement, the scheduling method comprising:

a first step of holding in advance reference brightness data, the reference brightness data being the brightness data acquired by the measurement unit in the past when weather was fine;

a second step of evaluating whether a difference between the brightness data acquired by the measurement unit and the reference brightness data is greater than or equal to a threshold value; and

a third step of rescheduling the measurement date on and time at which the measurement unit performs the measurement when a result of the evaluation indicates that the difference is greater than or equal to the threshold value.

### (Supplementary Note 14)

The scheduling method according to Supplementary note 13, further comprising:

a fourth step of holding installation place information indicating an installation place of the measurement unit in advance, wherein

in the third step,
when the result of the evaluation indicates that the difference is greater than or equal to the threshold value, weather information about an area including the installation place of the measurement unit is acquired, and
when weather indicated by the acquired weather information about the area is not fine, the measurement date on and time at which the measurement unit performs the measurement is rescheduled.

### (Supplementary Note 15)

The scheduling method according to Supplementary note 14, wherein

a plurality of the measurement units are provided,

in the fourth step, the installation place information indicating the installation place of each of the plurality of the measurement units is held in advance, and

in the third step,
when the weather indicated by the acquired weather information about the area is not fine, all the measurement units installed in the area are identified by referring to the installation place information, and
the measurement dates and times when all the measurement units positioned in the area perform the measurement are rescheduled.

### (Supplementary Note 16)

The scheduling method according to Supplementary note 14 or 15, wherein

the third step is for scheduling the measurement date and time when the measurement unit performs the measurement for inspection,

in the third step,
when the measurement date on and time at which the measurement unit performs the measurement for inspection is rescheduled, a scheduled date on and time at which the weather in the area is expected to improve is acquired based on the acquired weather information about the area,
the measurement unit is instructed to perform the measurement for checking the weather at the scheduled date and time,
it is evaluated whether the difference between the brightness data acquired by the measurement unit and the reference brightness data has become less than the threshold value, and
when the result of the evaluation indicates that the difference has become less than the threshold value, it is decided that the measurement unit performs the measurement for inspection on or after a date and time when the difference becomes less than the threshold value.

### (Supplementary Note 17)

The scheduling method according to any one of Supplementary notes 13 to 16, wherein

the measurement unit acquires three-dimensional data indicating a distance to a target and a shape of the target by performing the measurement,

in the second step,
brightness data indicating the intensity of the reflected light reflected by the specific target is extracted from the reference brightness data based on the three-dimensional data,
the brightness data indicating the intensity of the reflected light reflected by the specific target is extracted from the brightness data acquired by the measurement unit based on the three-dimensional data, and
it is evaluated whether the difference between the brightness data extracted from the brightness data acquired by the measurement unit and the brightness data extracted from the reference brightness data is greater than or equal to a threshold value.

### (Supplementary Note 18)

The scheduling method according to any one of Supplementary notes 13 to 16, wherein

the measurement unit acquires three-dimensional data indicating a distance to a target and a shape of the target by performing the measurement,

in the second step,
brightness data other than brightness data indicating the intensity of the reflected light reflected by the specific target is extracted from the reference brightness data based on the three-dimensional data,
brightness data other than the brightness data indicating the intensity of the reflected light reflected by the specific target is extracted from the brightness data acquired by the measurement unit based on the three-dimensional data, and
it is evaluated whether the difference between the brightness data extracted from the brightness data acquired by the measurement unit and the brightness data extracted from the reference brightness data is greater than or equal to a threshold value.

### (Supplementary Note 19)

A non-transitory computer readable medium storing a program for causing a computer for scheduling measurement date on and time at which a measurement unit performs measurement, the measurement unit being configured to acquire at least brightness data indicating intensity of reflected light of a beam by performing the measurement to execute:

a first procedure of holding in advance reference brightness data, the reference brightness data being the brightness data acquired by the measurement unit in the past when weather was fine;

a second procedure of evaluating whether a difference between the brightness data acquired by the measurement unit and the reference brightness data is greater than or equal to a threshold value; and

a third procedure of rescheduling the measurement date on and time at which the measurement unit performs the measurement when a result of the evaluation indicates that the difference is greater than or equal to the threshold value.

### REFERENCE SIGNS LIST

10 SCHEDULING DEVICE
11 SCHEDULER
12 MEASUREMENT DATA EVALUATION UNIT
13 MEASUREMENT UNIT INSTALLATION PLACE MANAGEMENT UNIT
14 WEATHER INFORMATION ACQUISITION UNIT
20 MEASUREMENT UNIT
30 COMPUTER
301 PROCESSOR
302 MEMORY
303 STORAGE
304 INPUT/OUTPUT INTERFACE
3041 DISPLAY DEVICE
3042 INPUT DEVICE
3043 SOUND OUTPUT DEVICE
305 COMMUNICATION INTERFACE

What is claimed is:

1. A scheduling system comprising:
a measurement unit configured to acquire at least brightness data indicating intensity of reflected light of a beam by performing measurement;
a scheduler configured to schedule a measurement date on and time at which the measurement unit performs the measurement; and
a measurement data evaluation unit configured to hold in advance reference brightness data, the reference brightness data being the brightness data acquired by the measurement unit in the past when weather was fine, and evaluate whether a difference between the brightness data acquired by the measurement unit and the reference brightness data is greater than or equal to a threshold value, wherein
when a result of the evaluation by the measurement data evaluation unit indicates that the difference is greater than or equal to the threshold value, the scheduler reschedules the measurement date on and time at which the measurement unit performs the measurement.

2. The scheduling system according to claim 1, further comprising:
an installation place management unit configured to hold installation place information indicating an installation place of the measurement unit in advance; and
a weather information acquisition unit configured to be able to acquire weather information, wherein
when the result of the evaluation by the measurement data evaluation unit indicates that the difference is greater than or equal to the threshold value, the scheduler acquires the weather information about an area including the installation place of the measurement unit from the weather information acquisition unit, and
when weather indicated by the weather information about the area acquired from the weather information acquisition unit is not fine, the scheduler reschedules the measurement date on and time at which the measurement unit performs the measurement.

3. The scheduling system according to claim 2, further comprising:
a plurality of the measurement units, wherein
the installation place management unit holds in advance the installation place information indicating the installation place of each of the plurality of the measurement units, and
when the weather indicated by the weather information about the area acquired from the weather information acquisition unit is not fine, the scheduler identifies all the measurement units installed in the area by referring to the installation place management unit, and
the scheduler reschedules the measurement dates and times when all the measurement units positioned in the area perform the measurement.

4. The scheduling system according to claim 2, wherein
the scheduler schedules the measurement date and time when the measurement unit performs the measurement for inspection
when the scheduler reschedules the measurement date on and time at which the measurement unit performs the measurement for inspection, the scheduler acquires, based on the weather information about the area acquired from the weather information acquisition unit, a scheduled date on and time at which the weather in the area is expected to improve, and the scheduler instructs the measurement unit to perform the measurement for checking the weather at the scheduled date and time, and
the measurement data evaluation unit evaluates whether the difference between the brightness data acquired by the measurement unit and the reference brightness data has become less than the threshold value, and
when the result of the evaluation by the measurement data evaluation unit indicates that the difference has become less than the threshold value, the scheduler decides that the measurement unit performs the measurement for inspection on or after a date and time when the difference becomes less than the threshold value.

5. The scheduling system according to claim 1, wherein
the measurement unit further acquires three-dimensional data indicating a distance to a target and a shape of the target by performing the measurement,
the measurement data evaluation unit extracts the brightness data indicating the intensity of the reflected light reflected by the specific target from the reference brightness data based on the three-dimensional data,
the measurement data evaluation unit extracts the brightness data indicating the intensity of the reflected light reflected by the specific target from the brightness data acquired by the measurement unit based on the three-dimensional data, and
the measurement data evaluation unit evaluates whether the difference between the brightness data extracted from the brightness data acquired by the measurement unit and the brightness data extracted from the reference brightness data is greater than or equal to the threshold value.

6. The scheduling system according to claim 1, wherein
the measurement unit further acquires three-dimensional data indicating a distance to a target and a shape of the target by performing the measurement,
the measurement data evaluation unit extracts brightness data other than brightness data indicating the intensity of the reflected light reflected by the specific target from the reference brightness data based on the three-dimensional data,
the measurement data evaluation unit extracts brightness data other than the brightness data indicating the intensity of the reflected light reflected by the specific target from the brightness data acquired by the measurement unit based on the three-dimensional data, and
the measurement data evaluation unit evaluates whether the difference between the brightness data extracted from the brightness data acquired by the measurement unit and the brightness data extracted from the reference brightness data is greater than or equal to the threshold value.

7. A scheduling device comprising:
a scheduler configured to schedule a measurement date on and time at which a measurement unit performs measurement, the measurement unit being configured to acquire at least brightness data indicating intensity of reflected light of a beam by performing the measurement; and
a measurement data evaluation unit configured to hold in advance reference brightness data, the reference brightness data being the brightness data acquired by the measurement unit in the past when weather was fine, and evaluate whether a difference between the brightness data acquired by the measurement unit and the reference brightness data is greater than or equal to a threshold value, wherein
when a result of the evaluation by the measurement data evaluation unit indicates that the difference is greater than or equal to the threshold value, the scheduler reschedules the measurement date on and time at which the measurement unit performs the measurement.

8. The scheduling device according to claim 7, further comprising:
an installation place management unit configured to hold installation place information indicating an installation place of the measurement unit in advance; and
a weather information acquisition unit configured to be able to acquire weather information, wherein
when the result of the evaluation by the measurement data evaluation unit indicates that the difference is greater than or equal to the threshold value, the scheduler acquires the weather information about an area including the installation place of the measurement unit from the weather information acquisition unit, and
when weather indicated by the weather information about the area acquired from the weather information acquisition unit is not fine, the scheduler reschedules the measurement date on and time at which the measurement unit performs the measurement.

9. The scheduling device according to claim 8, wherein:
a plurality of the measurement units are provided,
the installation place management unit holds in advance the installation place information indicating the installation place of each of the plurality of the measurement units, and
when the weather indicated by the weather information about the area acquired from the weather information acquisition unit is not fine, the scheduler refers to the installation place management unit to identify all the measurement units installed in the area, and
the scheduler reschedules the measurement dates and times when all the measurement units positioned in the area perform the measurement.

10. The scheduling device according to claim 8, wherein
the scheduler schedules the measurement date and time when the measurement unit performs the measurement for inspection,
when the scheduler reschedules the measurement date on and time at which the measurement unit performs the measurement for inspection, the scheduler acquires, based on the weather information about the area acquired from the weather information acquisition unit, a scheduled date on and time at which the weather in the area is expected to improve, and the scheduler instructs the measurement unit to perform the measurement for checking the weather at the scheduled date and time,
the measurement data evaluation unit evaluates whether the difference between the brightness data acquired by the measurement unit and the reference brightness data has become less than the threshold value, and
when the result of the evaluation by the measurement data evaluation unit indicates that the difference has become less than the threshold value, the scheduler decides that the measurement unit performs the measurement for inspection on or after a date and time when the difference becomes less than the threshold value.

11. The scheduling device according to claim 7, wherein
the measurement unit acquires three-dimensional data indicating a distance to a target and a shape of the target by performing the measurement,
the measurement data evaluation unit extracts brightness data other than brightness data indicating the intensity of the reflected light reflected by the specific target from the reference brightness data based on the three-dimensional data,
the measurement data evaluation unit extracts brightness data other than the brightness data indicating the intensity of the reflected light reflected by the specific target from the brightness data acquired by the measurement unit based on the three-dimensional data, and
the measurement data evaluation unit evaluates whether the difference between the brightness data extracted from the brightness data acquired by the measurement unit and the brightness data extracted from the reference brightness data is greater than or equal to the threshold value.

12. The scheduling device according to claim 7, wherein
the measurement unit acquires three-dimensional data indicating a distance to a target and a shape of the target by performing the measurement,
the measurement data evaluation unit extracts brightness data other than brightness data indicating the intensity of the reflected light reflected by the specific target from the reference brightness data based on the three-dimensional data,
the measurement data evaluation unit extracts brightness data other than the brightness data indicating the intensity of the reflected light reflected by the specific target from the brightness data acquired by the measurement unit based on the three-dimensional data, and
the measurement data evaluation unit evaluates whether the difference between the brightness data extracted from the brightness data acquired by the measurement unit and the brightness data extracted from the reference brightness data is greater than or equal to the threshold value.

13. A scheduling method performed by a scheduling device configured to schedule a measurement date on and time at which a measurement unit performs measurement, the measurement unit being configured to acquire at least brightness data indicating intensity of reflected light of a beam by performing the measurement, the scheduling method comprising:
a first step of holding in advance reference brightness data, the reference brightness data being the brightness data acquired by the measurement unit in the past when weather was fine;
a second step of evaluating whether a difference between the brightness data acquired by the measurement unit and the reference brightness data is greater than or equal to a threshold value; and
a third step of rescheduling the measurement date on and time at which the measurement unit performs the measurement when a result of the evaluation indicates that the difference is greater than or equal to the threshold value.

14. The scheduling method according to claim 13, further comprising:
a fourth step of holding installation place information indicating an installation place of the measurement unit in advance, wherein
in the third step,
when the result of the evaluation indicates that the difference is greater than or equal to the threshold value, weather information about an area including the installation place of the measurement unit is acquired, and
when weather indicated by the acquired weather information about the area is not fine, the measurement date on and time at which the measurement unit performs the measurement is rescheduled.

15. The scheduling method according to claim 14, wherein
a plurality of the measurement units are provided,
in the fourth step, the installation place information indicating the installation place of each of the plurality of the measurement units is held in advance, and
in the third step,
when the weather indicated by the acquired weather information about the area is not fine, all the measurement units installed in the area are identified by referring to the installation place information, and
the measurement dates and times when all the measurement units positioned in the area perform the measurement are rescheduled.

16. The scheduling method according to claim 14,
wherein the third step is for scheduling the measurement date and time when the measurement unit performs the measurement for inspection,
in the third step,
when the measurement date on and time at which the measurement unit performs the measurement for inspection is rescheduled, a scheduled date on and time at which the weather in the area is expected to improve is acquired based on the acquired weather information about the area,
the measurement unit is instructed to perform the measurement for checking the weather at the scheduled date and time,
it is evaluated whether the difference between the brightness data acquired by the measurement unit and the reference brightness data has become less than the threshold value, and
when the result of the evaluation indicates that the difference has become less than the threshold value, it is decided that the measurement unit performs the measurement for inspection on or after a date and time when the difference becomes less than the threshold value.

17. The scheduling method according to claim 13, wherein
the measurement unit acquires three-dimensional data indicating a distance to a target and a shape of the target by performing the measurement,
in the second step,
brightness data indicating the intensity of the reflected light reflected by the specific target is extracted from the reference brightness data based on the three-dimensional data,
the brightness data indicating the intensity of the reflected light reflected by the specific target is extracted from the brightness data acquired by the measurement unit based on the three-dimensional data, and
it is evaluated whether the difference between the brightness data extracted from the brightness data acquired by the measurement unit and the brightness data extracted from the reference brightness data is greater than or equal to a threshold value.

18. The scheduling method according to claim 13, wherein
the measurement unit acquires three-dimensional data indicating a distance to a target and a shape of the target by performing the measurement,
in the second step,
brightness data other than brightness data indicating the intensity of the reflected light reflected by the specific target is extracted from the reference brightness data based on the three-dimensional data,
brightness data other than the brightness data indicating the intensity of the reflected light reflected by the specific target is extracted from the brightness data acquired by the measurement unit based on the three-dimensional data, and
it is evaluated whether the difference between the brightness data extracted from the brightness data acquired by the measurement unit and the brightness data extracted from the reference brightness data is greater than or equal to a threshold value.

19. (canceled)
